(19) United States
(12) Patent Application Publication
(10) Pub. No.: US 2015/0198305 A1
(43) Pub. Date: Jul. 16, 2015

(54) Light Source System

(71) Applicant: HITACHI METALS, LTD., Tokyo (JP)

(72) Inventors: Yoshinori SUNAGA, Hitachinaka (JP); Masahiko KOBAYASHI, Hitachi (JP)

(21) Appl. No.: 14/574,178

(22) Filed: Dec. 17, 2014

(30) Foreign Application Priority Data
Jan. 14, 2014 (JP) 2014-003937

(51) Int. Cl. F21V 13/04; F21K 99/00; F21V 29/00

(52) U.S. Cl. CPC F21V 13/04; F21V 29/22; F21K 9/56

(57) ABSTRACT

A light source system includes a light source array including a plurality of arrayed excitation light sources that emit an excitation light, a fluorescent member including a phosphor and emitting a fluorescence by the excitation light, first and second lenses that are arranged in parallel, and a dichroic mirror that is arranged between the first and second lenses. The first lens collects and collimates the excitation light. The second lens focuses the excitation light emitted from the first lens and transmitted through the dichroic mirror to the fluorescent member and collimates the fluorescence emitted from the fluorescent member. The dichroic mirror reflects the fluorescence collimated by the second lens in a direction inclined with respect to an arrangement direction of the first and second lenses. The excitation light emitted from the second lens is incident on the fluorescent member in a defocused state to excite the phosphor.

The present application is based on Japanese patent application No.2014-003937 filed on Jan. 14, 2014, the entire contents of which are incorporated herein by reference.

### BACKGROUND OF THE INVENTION

1. Field of the Invention

The invention relates to a light source system to produce fluorescence by exciting a phosphor by excitation light.

2. Description of the Related Art

A light source system is known in which excitation light emitted from plural excitation light sources produces fluorescent light with a wavelength different from the excitation light (see e.g. JP-A-2012-133337).

The light source system disclosed in IP-A-2012-133337 is provided with first and second solid light source units arranged to face each other, plural reflectors provided between the first and second solid light source units, a light collecting portion composed of plural lenses which collect and collimate excitation light reflected by each reflector, a dichroic mirror for reflecting the excitation light collimated by the light collecting portion, and a fluorescent member to produce fluorescent light by the excitation light reflected by the dichroic mirror. This dichroic mirror reflects blue excitation light and transmits the yellow fluorescent light.

The first and second solid light source units are each provided with plural excitation light sources arranged in parallel, plural condenser lenses collecting and collimating excitation light emitted from the plural excitation light sources, and a heatsink for dissipating heat generated by the plural excitation light sources. The excitation light emitted from the plural excitation light sources is condensed by the reflector and the lenses and is then made incident on the fluorescent member, thereby allowing a high-intensity bright light source to be obtained.

### SUMMARY OF THE INVENTION

For the light source system disclosed in JP-A-2012-133337, it may be difficult to accurately arrange the plural excitation light sources and the condenser lenses and to accurately align the condenser lenses with the respectively corresponding reflectors and the light collecting portion. In addition, a problem may arise that, when the excitation light to be incident on the fluorescent member is excessively condensed, heat of the excitation light causes the deterioration of the fluorescent member.

It is an object of the invention to provide a light source system that offers an accurate alignment as well as a simple structure and prevents the deterioration of the fluorescent member.

(1) According to one embodiment of the invention, a light source system comprises:
a light source array comprising a plurality of arrayed excitation light sources that emit an excitation light;
a fluorescent member including a phosphor and emitting a fluorescence by the excitation light;
first and second lenses that are arranged in parallel so as to share an optical axis; and
a dichroic mirror that is arranged between the first and second lenses, transmits the excitation light and reflects the fluorescence,
wherein the first lens collects and collimates the excitation light emitted from the plurality of excitation light sources,
wherein the second lens focuses the excitation light emitted from the first lens and transmitted through the dichroic mirror to the fluorescent member and collimates the fluorescence emitted from the fluorescent member,
wherein the dichroic mirror reflects the fluorescence collimated by the second lens in a direction inclined with respect to an arrangement direction of the first and second lenses, and
wherein the excitation light emitted from the second lens is incident on the fluorescent member in a defocused state to excite the phosphor.

### Effects of the Invention

According to one embodiment of the invention, a light source system can be provided that offers an accurate alignment as well as a simple structure and prevents the deterioration of the fluorescent member.

### BRIEF DESCRIPTION OF THE DRAWINGS

Next, the present invention will be explained in more detail in conjunction with appended drawings, wherein:

FIG. 1A is a schematic view showing a configuration example of a light source system in a first embodiment of the present invention as viewed from the upper surface of a light source unit;

FIG. 1B is a side view showing a light source array;

FIG. 2 is an explanatory diagram illustrating excitation light incident on a fluorescent member;

FIG. 3A is a schematic view showing a configuration example of a light source system in a modification of the first embodiment of the invention as viewed from the upper surface of the light source unit;

FIG. 3B is a cross sectional view showing an optical fiber tape taken along a line A-A in FIG. 3A;

FIG. 4 is a schematic view showing a configuration example of a light source system in a second embodiment of the invention; and

FIG. 5 is a schematic plan view showing a light source unit in the second embodiment as viewed in the direction of arrow B in FIG. 4.

### DETAILED DESCRIPTION OF THE PREFERRED EMBODIMENTS

### First Embodiment

A light source system of the invention is used for, e.g., devices requiring high-power point light sources, such as projector.

Configuration of Light Source System 1

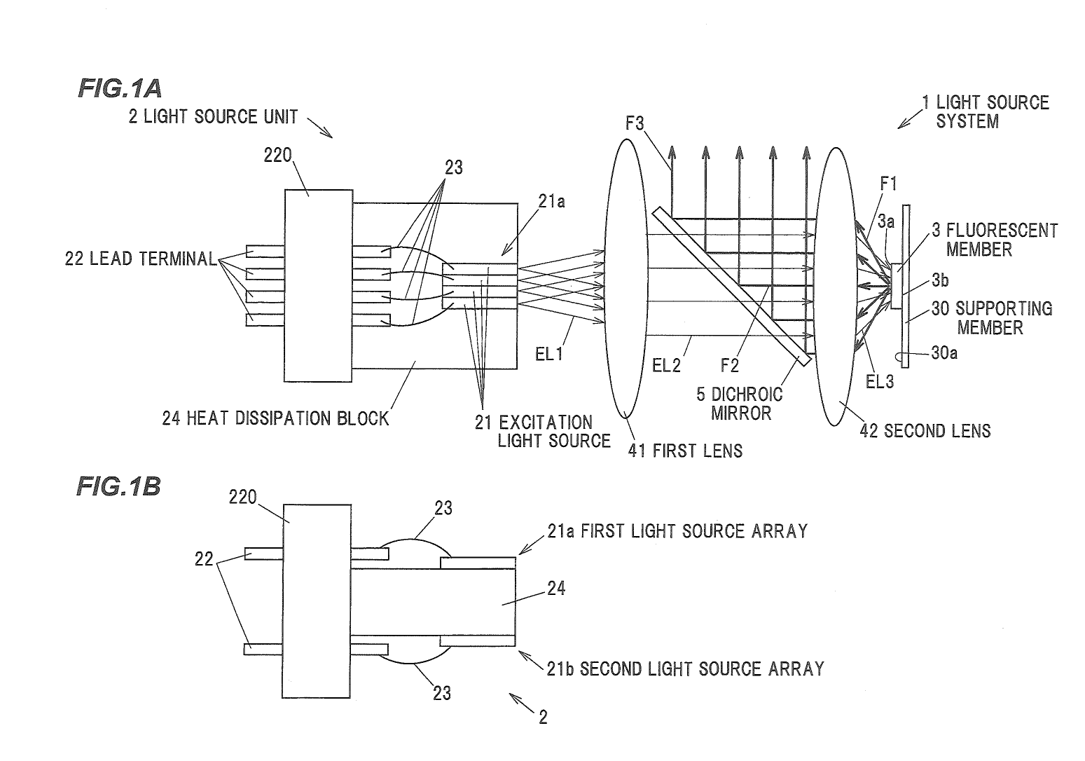

FIG. 1A is a schematic view showing a configuration example of a light source system 1 in the first embodiment of the invention as viewed from the upper surface of a light source unit 2 and FIG. 1B is a side view showing the light source unit 2.

The light source system 1 is provided with the light source unit 2, a fluorescent member 3, first and second lenses 41 and 42 and a dichroic mirror 5. The light source unit 2 has a light source array composed of plural arrayed excitation light sources 21 (eight in the first embodiment) emitting excitation light EL1. and a heat dissipation block 24 as a heat dissipation member for dissipating heat generated by the plural excitation light sources 21. The fluorescent member 3 contains phosphor and emits fluorescence F1 upon exposure to the excitation light EL1. The first and second lenses 41 and 42 are arranged in parallel so as to share an optical axis. The dichroic mirror 5 is arrange between the first and second lenses 41 and 42, transmits excitation light EL2 emitted from the first lens 41 and reflects fluorescence F2 emitted from the second lens 42.

In the first embodiment, the light source unit 2, the first lens 41, the dichroic mirror 5, the second lens 42 and the fluorescent member 3 are arranged in line along the optical axis of the first and second lenses 41 and 42.

The first lens 41 is arranged on the light source unit 2 side of the dichroic mirror 5 to collect and collimate the excitation light EL1 emitted from the plural excitation light sources 21 (see the excitation light EL2 in FIG. 1A).

The second lens 42 is arranged on the fluorescent member 3 side of the dichroic mirror 5 to focus the excitation light EL2 transmitted through the dichroic mirror 5 to the fluorescent member 3 (see excitation light EL3 in FIG. 1A) and to collimate the fluorescence F1 emitted from the fluorescent member 3 (see the fluorescence F2 in FIG. 1A).

Although a collimating lens for collimating the excitation light EL1 and that for collimating the fluorescence F1 are respectively used as the first and second lenses 41 and 42 in the first embodiment, it is not limited thereto and it is possible to use lenses suitable for the intended use. The first and second lenses 41 and 42 preferably have a large numerical aperture NA so that more excitation light EL1 and fluorescence F1 are collected. The collimating lens may be a Galilean lens formed by combining concave and convex lenses or a Keplerian lens formed by combining convex lenses.

The heat dissipation block 24 of the light source unit 2 has a thickness in a direction orthogonal to the optical axis of the first and second lenses 41 and 42 (a direction perpendicular to an arrangement direction of the first and second lenses 41 and 42).

The light source array is composed of first and second light source arrays 21a and 21b which are each composed of plural excitation light sources 21 arranged in line and are arranged so as to sandwich the heat dissipation block 24 in the thickness direction thereof. FIG. 1A shows only the first light source array 21a. In the first embodiment, each of the first and second light source arrays 21a and 21b is composed of four excitation light sources 21 arranged in line.

The first and second light source arrays 21a and 21b are arranged so that the heat dissipation block 24 is sandwiched therebetween in a direction intersecting with the arrangement direction of the first and second lenses 41 and 42, as shown in FIG. 1B. Therefore, the heat dissipation block 24 absorbs heat generated by the plural excitation light sources 21, and the heat is transferred to a substrate 220 from the heat dissipation block 24 and is then dissipated.

The excitation light sources 21 are configured to have a semiconductor, e.g., a light-emitting diode (LED) or a laser diode (LD), etc., and are electrically connected by bonding wires 23 respectively to lead terminals 22 which are attached to the substrate 220.

In the first embodiment, each of the first and second light source arrays 21a and 21b is a laser source array having laser sources as the plural excitation light sources 21 and the excitation light EL1 is blue laser light with an emission intensity peak at around 450 nm. Alternatively, the excitation light source 21 may be an excitation light source emitting colored light with an emission intensity peak of other than around 450 nm as long as light with a wavelength capable of exciting phosphor in the fluorescent member 3 is emitted.

The dichroic mirror 5, in which, e.g., a dielectric multilayer film formed by depositing layers of metal oxide is provided on a mirror surface of a glass, selectively reflects light with a specific wavelength and transmits light with other wavelengths. In the first embodiment, the dichroic mirror 5 selectively reflects light with a wavelength in a range of the fluorescence F2 emitted from the second lens 42 (500 nm to 600 nm), and transmits light with other wavelengths including the excitation light EL2 which is emitted from the first lens 41 and has an emission peak intensity at around 450 nm.

The dichroic mirror 5 is inclined with respect to the arrangement direction of the first and second lenses 41 and 42 so that the collimated fluorescence F2 from the second lens 42 is reflected in a direction parallel to the first and second lenses 41 and 42 (see fluorescence F3 in FIG. 1A).

The fluorescent member 3 is formed of, e.g., a translucent member having optical transparency, such as silicon resin or epoxy resin, containing granular phosphor. In the first embodiment, the fluorescent member 3 is formed in a plate shape about 2 mm to 3 mm on a side to obtain a point light source. The fluorescent member 3 is fixed to a heat-dissipative supporting member 30 by, e.g., an adhesive, etc. The supporting member 30 is formed of, e.g., a metal plate having high thermal conductivity.

A surface 30a of the supporting member 30 functions as a reflective surface. The excitation light EL3 emitted from the second lens 42 and the fluorescence F1 emitted from the fluorescent member 3 are partially reflected by the surface 30a of the supporting member 30.

The phosphor absorbs and converts the excitation light EL3 (blue laser light) into green fluorescence F1 with an emission intensity peak at around 530 nm. The phosphor used here is blue-excited green-emitting phosphor represented by, e.g., YAG (Yttrium Aluminium Garnet) phosphor or SiAlON phosphor, etc.

In the first embodiment, distribution of the dispersed phosphor in the thickness direction of the fluorescent member 3 is denser on a front surface 3a side (on the second lens 42 side) than in the middle portion and on a back surface 3b side (on the supporting member 30 side). In other words, the phosphor is unevenly distributed and concentrated on the front surface 3a side in the fluorescent member 3.

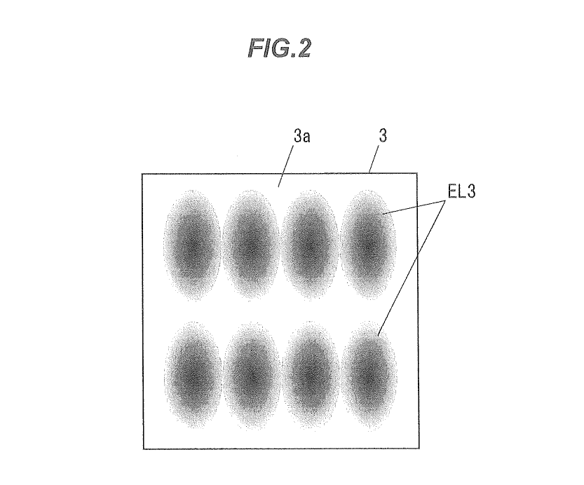

The fluorescent member 3 is arranged at a position off the focal point of the second lens 42 and the excitation light EL3 emitted from the second lens 42 is incident on the fluorescent member 3 through the front surface 3a in a defocused state, as shown in FIG. 2. The excitation light EL3 incident on the fluorescent member 3 excites the phosphor in the vicinity of the front surface 3a and the fluorescence F1 is thereby emitted from the front surface 3a.

Operation of Light Source System 1

Next, an operation of the light source system 1 will be described.

The excitation light EL1 emitted from the plural excitation light sources 21 toward the first lens 41 is collected and collimated by the first lens 41. The collimated excitation light EL2 from the first lens 41 is transmitted through the dichroic mirror 5 and is incident on the second lens 42. The excitation light EL3 emitted from the second lens 42 is focused to the fluorescent member 3 and is incident on the fluorescent member 3 through the front surface 3a in a defocused state.

Then, the phosphor of the fluorescent member 3 in the vicinity of the front surface 3a is excited by the excitation light EL3 and the fluorescence F1 is emitted from the front surface 3a toward the second lens 42. The fluorescence F1 emitted from the fluorescent member 3 is collected and collimated by the second lens 42. The collimated fluorescence F2 from the second lens 42 is reflected by the dichroic mirror 5 in a direction inclined with respect to the arrangement direction of the first and second lenses 41 and 42 (a direction parallel to the first and second lenses 41 and 42). The fluorescence F3 reflected by the dichroic mirror 5 propagates to an external device (not shown).

Functions and Effects of the First Embodiment

The following functions and effects are obtained in the first embodiment.

(1) The light source array (the first and second light source arrays 21a and 21b) composed of the plural arrayed excitation light sources 21 is used and the excitation light EL1 emitted from the plural excitation light sources 21 is collected by one lens (the first lens 41). The structure is thus simple but allows for accurate alignment and a high-power point light source is thereby obtained.

(2) Since the excitation light EL3 emitted from the second lens 42 is incident on the fluorescent member 3 in a defocused, out-of-focus state, it is possible to reduce burn-in on the fluorescent member 3 and thereby to suppress deterioration of the fluorescent member 3.

(3) Since the fluorescent member 3 is attached to the supporting member 30 having heat dissipation properties, it is possible to efficiently dissipate heat generated in the fluorescent member 3.

(4) Since the surface 30a of the supporting member 30 functions as a reflective surface, a portion of the excitation light EL3 emitted from the second lens 42 and scattered around the fluorescent member 3 without being incident thereon can be reflected and made incident on the fluorescent member 3. Similarly, a portion of the fluorescence F1 emitted from the fluorescent member 3 and scattered around the second lens 42 without being collected can be reflected by the surface 30a and made incident on the second lens 42.

(5) The light source array (the first and second light source arrays 21a and 21b) is a laser source array having laser sources as the plural excitation light sources 21. Therefore, it is possible to make intense excitation light EL1 incident on the fluorescent member 3 and to extract intense fluorescence F1.

(6) Since the first and second light source arrays 21a and 21b are arranged so that the heat dissipation block 24 having a thickness in a direction orthogonal to the optical axis of the first and second lenses 41 and 42 is sandwiched in the thickness direction thereof, it is possible to efficiently dissipate heat generated in each excitation light source 21.

Modification of the First Embodiment

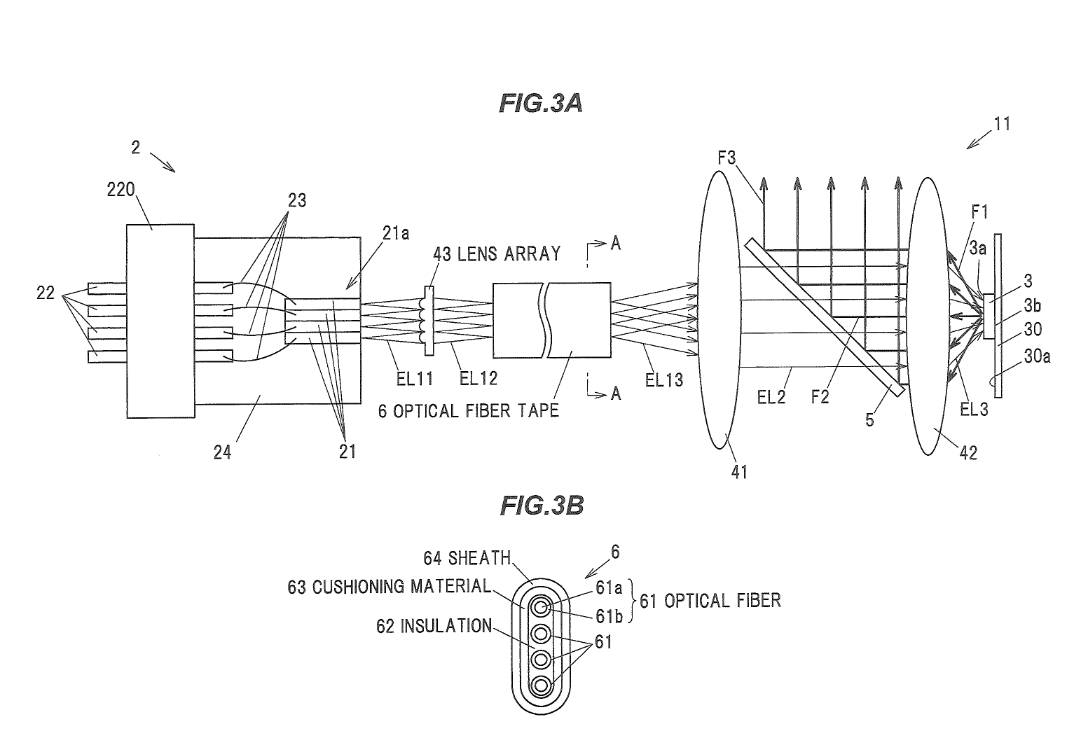

Next, a modification of the first embodiment will be described in reference to FIG. 3.

Configuration of Light Source System 11

FIG. 3A is a schematic view showing a configuration example of a light source system 11 in a modification of the first embodiment of the invention as viewed from the upper surface of the light source unit 2 and FIG. 3B is a cross sectional view showing an optical fiber tape 6 taken on line A-A of FIG. 3A.

Constituent elements having the same functions as those of the light source system 1 in the first embodiment are denoted by the same reference numerals in FIG. 3 and the overlapping explanation thereof will be omitted.

The light source system 11 in the modification is different from the light source system 1 in the first embodiment in that a lens array 43 and the optical fiber tape 6, which optically couple the plural excitation light sources 21 to the first lens 41, are further provided.

As shown in FIG. 3A, the lens array 43 and the optical fiber tape 6 are arranged between the light source unit 2 and the first lens 41. In more detail, the lens array 43 is arranged on the light source unit 2 side and the optical fiber tape 6 is arranged on the first lens 41 side.

Although the light source unit 2, the lens array 43, the optical fiber tape 6, the first lens 41, the dichroic mirror 5, the second lens 42 and the fluorescent member 3 are arranged in line along the optical axis of the first and second lenses 41 and 42 in the modification, it is not limited thereto. For example, the optical fiber tape 6 may be bent so that the light source unit 2 is arranged at a position off the optical axis of the first and second lenses 41 and 42.

The lens array 43 is formed by arraying lenses which respectively collect beams of excitation light EL11 emitted from the plural excitation light sources 21. In this embodiment, plural optical fibers 61 extending in the arrangement direction of the first and second lenses 41 and 42 (a direction parallel to the optical axis of the first and second lenses 41 and 42) are integrated into a tape shape, thereby forming the optical fiber tape 6.

As shown in FIG. 3B, the optical fiber tape 6 is composed of plural optical fibers 61 (four in FIG. 3B) each comprising a core 61a and a cladding 61b, an insulation 62 covering all the plural optical fibers 61 together, a cushioning material 63 covering the outer periphery of the insulation 62, and a sheath 64 further covering the outer periphery of the cushioning material 63.

Although the optical fiber tape 6 formed by integrating four optical fibers 61 corresponding to the first light source array 21a into a tape shape is shown in FIG. 3B, it is not limited thereto. An optical fiber tape formed by integrating, e.g., eight optical fibers 61 corresponding to the first and second light source arrays 21a and 21b into a tape shape can be also used.

In this embodiment, optical coupling between the excitation light sources 21 (the light source unit 2) and the optical fibers 61 (the optical fiber tape 6) is made more reliable by arranging the lens array 43 between the plural excitation light sources 21 and the plural optical fibers 61. However, the lens array 43 does not need to be provided and optical coupling between the excitation light sources 21 and the optical fibers 61 may be a rough butt joint.

The beams of excitation light EL11 emitted from the plural excitation light sources 21 are respectively incident on the lenses of the lens array 43. Beams of excitation light EL12 emitted from the lens array 43 are incident on the cores 61a of the corresponding optical fibers 61. Excitation light EL13 propagating through and exiting from the optical fibers 61 is collected and collimated by the first lens 41. The path after this continues in the same way as the first embodiment and a point light source is obtained.

Functions and Effects of the Modification of the First Embodiment

In the modification of the first embodiment, the following functions and effects are obtained in addition to the functions and effects (1) to (6) of the first embodiment.

The light source system 11 is provided with the plural optical fibers 61 optically coupling the plural excitation light sources 21 to the first lens 41. This allows the light source unit 2 generating a large amount of heat to be arranged at a distance from a light distribution mechanism including the first and second lenses 41 and 42, etc. Therefore, it is possible to improve heat dissipation efficiency by, e.g., arranging the light source unit 2 in the vicinity of a separately-provided heat dissipation mechanism.

### Second Embodiment

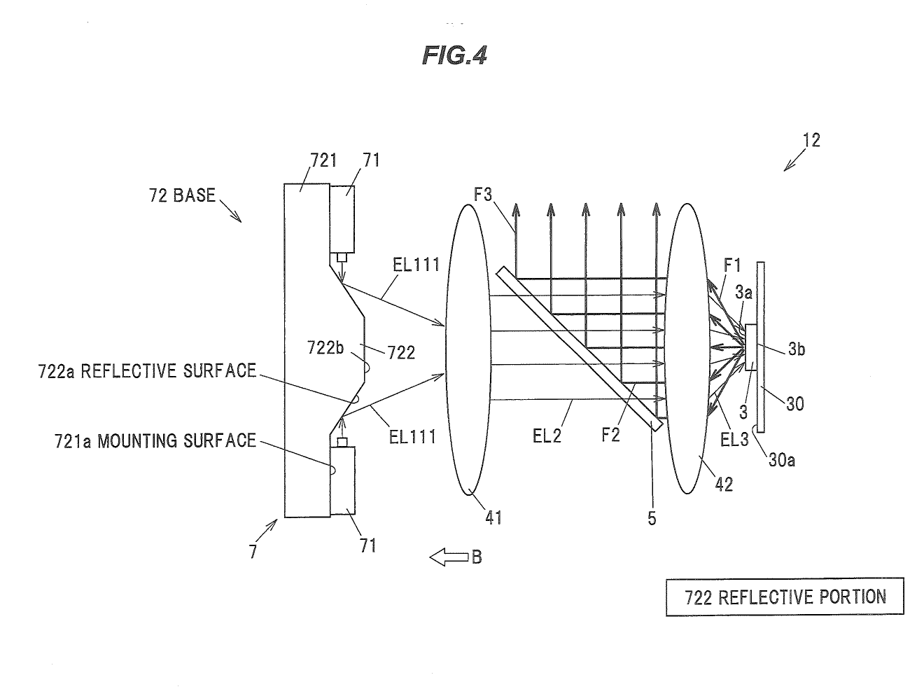

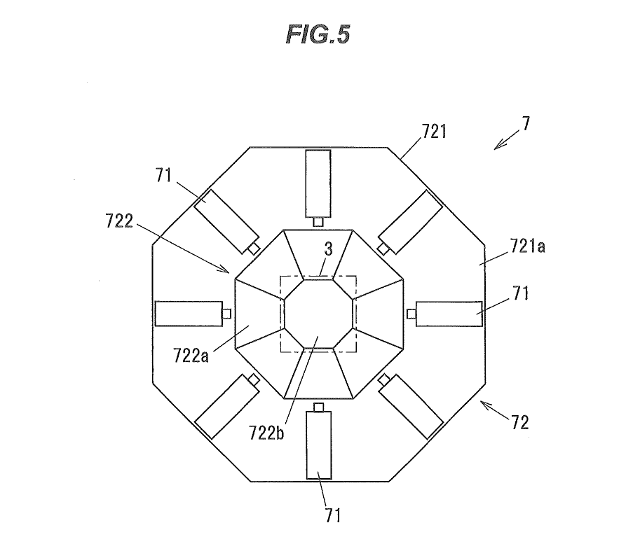

Next, the second embodiment will be described in reference to FIGS. 4 and 5.

Configuration of Light Source System 12

FIG. 4 is a schematic view showing a configuration example of a light source system 12 in the second embodiment of the invention. FIG. 5 is a schematic plan view showing a light source unit 7 in the second embodiment as viewed in the direction of arrow B in FIG. 4. In FIG. 5, the fluorescent member 3 is indicated by a dash-dot-dot line.

Constituent elements having the same functions as those of the light source system 1 in the first embodiment are denoted by the same reference numerals in FIGS. 4 and 5 and the overlapping explanation thereof will be omitted.

In the light source system 12 of the second embodiment, a configuration of the light source unit 7 is different from the light source unit 2 of the light source system 1 in the first embodiment and the remaining configuration is the same as the first embodiment.

The light source unit 7 is provided with a heat-dissipative base 72 on which plural excitation light sources 71 (eight in the second embodiment) are mounted. The base 72 integrally has a mounting portion 721 having a flat mounting surface 721a for mounting the plural excitation light sources 71 and a reflective portion 722 having a reflective surface 722a for reflecting excitation light EL111 emitted from the plural excitation light sources 71. The reflective surface 722a is inclined with respect to the mounting surface 721a.

The base 72 has heat dissipation properties and is formed of, e.g., a metal material having high thermal conductivity or a ceramic such as silicon carbide (SiC) or zirconia (ZrO₂). A surface of the base 72 has a function as a reflective surface for reflecting light scattered in the periphery.

As shown in FIG. 4, a facing surface 722b facing the front surface 3a of the fluorescent member 3 is formed on the reflective portion 722 and the reflective surface 722a is formed continuously from the facing surface 722b to the mounting surface 721a.

The angle formed between the reflective surface 722a and the mounting surface 721a is set so that the excitation light EL111 emitted from the excitation light sources 71 mounted on the mounting surface 721a is reflected by the reflective surface 722a and is accurately incident on the fluorescent member 3 through the first and second lenses 41 and 42. In the second embodiment, the angle formed between the reflective surface 722a and the mounting surface 721a is a blunt angle and is desirably not less than 135°. The mounting surface 721a is parallel to the facing surface 722b.

As shown in FIG. 5, the mounting portion 721 has an octagonal rim. The reflective portion 722 is formed concentrically with the mounting portion 721 and the reflective surface 722a has an octagonal rim in the same manner as the rim of the mounting portion 721. The plural excitation light sources 71 are arranged at equal intervals so as to surround the reflective portion 722 when viewed in a direction perpendicular to the mounting surface 721a (the direction of arrow B in FIG. 4), thereby forming the light source array.

The shape of the rims of the mounting portion 721 and the reflective portion 722 does not necessarily need to be octagonal and may be, e.g., rectangular or circular. As such, the shape of the rim is not specifically limited.

The excitation light EL111 emitted from the plural excitation light sources 71 along the mounting surface 721a is reflected by the reflective surface 722a and is then collected and collimated by the first lens 41. The path after this continues in the same way as the first embodiment and a point light source is obtained.

Functions and Effects of the Second Embodiment

In the second embodiment, the following functions and effects are obtained in addition to the functions and effects (1) to (5) of the first embodiment.

Since the base 72 has heat dissipation properties, heat generated by the plural excitation light sources 71 is transferred to the base 72 and is dissipated to the outside from the base 72. As such, heat can be efficiently dissipated.

In addition, the excitation light EL111 emitted from the plural excitation light sources 71 is reflected by the reflective surface 722a of the reflective portion 722 of the base 72 and is collected by the first lens 41. Therefore, it is not necessary to separately provide an optical member such as reflecting mirror or condenser lens and it is thus possible to reduce the cost and to downsize the light source system 12.

In addition, the excitation light EL111 emitted from the plural excitation light sources 71 is reflected by the reflective surface 722a and is then focused to the fluorescent member 3 through the first lens 41. This allows the excitation light EL3 to be focused to the fluorescent member 3 which is smaller than the reflective portion 722 in a plan view (FIG. 5) and a point light source is easily obtained.

### SUMMARY OF THE EMBODIMENTS

Technical ideas understood from the embodiments will be described below citing the reference numerals, etc., used for the embodiments. However, each reference numeral, etc., described below is not intended to limit the constituent elements in the claims to the members, etc., specifically described in the embodiments.

[1] A light source system (1, 11, 12), comprising: a light source array comprising a plurality of arrayed excitation light sources (21) that emit an excitation light; a fluorescent member (3) including a phosphor and emitting a fluorescence by the excitation light; first and second lenses (41, 42) that are arranged in parallel so as to share an optical axis; and a dichroic mirror (5) that is arrange between the first and second lenses (41, 42), transmits the excitation light and reflects the fluorescence, wherein the first lens (41) collects and collimates the excitation light emitted from the plurality of excitation light sources (21), the second lens (42) focuses the excitation light emitted from the first lens (41) and transmitted through the dichroic mirror (5) to the fluorescent member (3) and collimates the fluorescence emitted from the fluorescent member (3), the dichroic mirror (5) reflects the fluorescence collimated by the second lens (42) in a direction inclined with respect to an arrangement direction of the first and second lenses (41, 42), and the excitation light emitted from the second lens (42) is incident on the fluorescent member (3) in a defocused state to excite the phosphor.

[2] The light source system (1) described in [1], wherein the light source array comprises first and second light source arrays (21a, 21b) that each comprise the plurality of excitation light sources (21) arranged in line and are placed so as to sandwich a heat dissipation member (heat dissipation block 24) having a thickness in a direction orthogonal to the optical axis of the first and second lenses (41, 42).

[3] The light source system (12) described in [1], further comprising: a heat-dissipative base (72) for mounting the plurality of excitation light sources (71), wherein the base (72) comprises a mounting surface (721a) for mounting the plurality of excitation light sources (71) and a reflective surface (722a) formed to be inclined with respect to the mounting surface (721a) to reflect the excitation light emitted from the plurality of excitation light sources (71).

[4] The light source system (12) described in [3], wherein the plurality of excitation light sources (71) are arranged to surround a reflective portion (722) comprising the reflective surface (722a).

[5] The light source system (1, 11, 12) described in any of [1] to [4], further comprising: a plurality of optical fibers (61) for optically coupling the plurality of excitation light sources (21, 71) to the first lens (41), wherein the excitation light emitted from the plurality of excitation light sources (21, 71) is incident on the first lens (41) via the plurality of optical fibers (61).

[6] The light source system (1, 11, 12) described in any of [1] to [5], wherein the fluorescent member (3) is attached to a heat-dissipative supporting member (30), and the excitation light and the fluorescence are partially reflected by a surface of the supporting member (30).

[7] The light source system (1, 11, 12) described in any of [1] to [6], wherein the light source array comprises a laser light source array comprising laser light sources as the plurality of excitation light sources (21, 71).

Although the embodiments of the invention have been described, the invention according to claims is not to be limited to the embodiments. Further, please note that all combinations of the features described in the embodiments are not necessary to solve the problem of the invention.

In addition, the invention can be appropriately modified and implemented without departing from the gist thereof. For example, although blue laser light is used as excitation light and green light as fluorescence in the embodiments, it is not limited thereto. It is possible to change light color depending on the intended use.

In addition, the configuration in which the plural optical fibers 61 are further provided between the light source unit 2 and the first lens 41 has been described as the modification of the first embodiment, the light source system 12 in the second embodiment may be further provided with the plural optical fibers 61 between the light source unit 7 and the first lens 41.

In addition, the number and arrangement of the excitation light sources 21 and 71 are not specifically limited.

What is claimed is:

1. A light source system, comprising:
a light source array comprising a plurality of arrayed excitation light sources that emit an excitation light;
a fluorescent member including a phosphor and emitting a fluorescence by the excitation light;
first and second lenses that are arranged in parallel so as to share an optical axis; and
a dichroic mirror that is arranged between the first and second lenses, transmits the excitation light and reflects the fluorescence,
the first lens collects and collimates the excitation light emitted from the plurality of excitation light sources,
wherein the second lens focuses the excitation light emitted from the first lens and transmitted through the dichroic mirror to the fluorescent member and collimates the fluorescence emitted from the fluorescent member,
wherein the dichroic mirror reflects the fluorescence collimated by the second lens in a direction inclined with respect to an arrangement direction of the first and second lenses, and
wherein the excitation light emitted from the second lens is incident on the fluorescent member in a defocused state to excite the phosphor.

2. The light source system according to claim 1, wherein the light source array comprises first and second light source arrays that each comprise the plurality of excitation light sources arranged in line and are placed so as to sandwich a heat dissipation member having a thickness in a direction orthogonal to the optical axis of the first and second lenses.

3. The light source system according to claim 1, further comprising a heat-dissipative base for mounting the plurality of excitation light sources,
wherein the base comprises a mounting surface for mounting the plurality of excitation light sources and a reflective surface formed to be inclined with respect to the mounting surface to reflect the excitation light emitted from the plurality of excitation light sources.

4. The light source system according to claim 3, wherein the plurality of excitation light sources are arranged to surround a reflective portion comprising the reflective surface.

5. The light source system according to claim 1, further comprising a plurality of optical fibers for optically coupling the plurality of excitation light sources to the first lens,
wherein the excitation light emitted from the plurality of excitation light sources is incident on the first lens via the plurality of optical fibers.

6. The light source system according to claim 1, wherein the fluorescent member is attached to a heat-dissipative supporting member, and
wherein the excitation light and the fluorescence are partially reflected by a surface of the supporting member.

7. The light source system according to claim 1, wherein the light source array comprises a laser light source array comprising a laser light source as that the plurality of excitation light sources.
